(19) United States
(12) Patent Application Publication
(10) Pub. No.: US 2006/0039815 A1
(43) Pub. Date: Feb. 23, 2006

(54) Fluid displacement pump

(76) Inventors: Allan Chertok, Bedford, MA (US); Mimmo Elia, Watertown, MA (US)

Correspondence Address: Michael J. Mlotkowski;Roberts, Mlotkowski & Hobbes, PC, Suite 850, 8270 Greensboro Drive, McLean, VA, 22102, US

(21) Appl. No.: 10/920,474

(22) Filed: Aug. 18, 2004

(51) Int. Cl. F01C 1/02; F01C 1/063; F03C 2/00; F03C 4/00; F04C 18/00

(52) U.S. Cl. 418/61.3

(57) ABSTRACT

An internal gear fluid displacement pump. The fluid displacement pump includes an outer gear having internal teeth disposed about an inner surface thereof, an annular element constituting the rotor of an electric motor, this element having an internal diameter substantially equivalent to an external diameter of the outer gear, the annular motor rotor affixed to the outer gear, an inner gear having external teeth disposed about an outer surface thereof for meshing with the internal teeth of the outer gear, the inner gear having fewer teeth than the outer gear, the internal teeth of the outer gear and the external teeth of the inner gear defining a plurality of expansion and pumping chambers when the outer gear is rotatably driven by the electric motor rotor, the bearing surface operable to support the outer gear during rotation thereof, a motor stator element electromagnetically engaging the annular motor rotor element for rotationally driving the outer gear, the motor stator having a soft ferromagnetic core and coil winding assembly and a non-magnetic housing disposed between the motor stator coil windings and the annular magnet, the outer diameter of the annular motor rotor element and the inner diameter of the non-magnetic housing constituting a journal and bearing system which is lubricated by the pumped fluid and is effective to maintain a fixed electromagnetic circuit gap between the inner diameter of the motor stator and the outer diameter of the annular motor rotor element during the operation of the pump.

### FIELD

The present invention relates to rotary machines for the pumping of fluids having eccentrically mounting intermeshing cycloidal gears.

### BACKGROUND

Generated rotor (gerotor) and trochoidal gear fluid displacement pumps are internal gear pumps having an inner gear and an outer gear. In gerotor designs, the inner gear has one less tooth than the outer gear, while in trochoidal designs, the inner gear has two less teeth than the outer gear. Because of this difference in the number of teeth a partial vacuum is created where the fluid is transferred. In conventional designs, typically, the inner gear is turned by a prime mover and rotates a larger outer gear.

Gerotor, trochoidal gear and other internal gear-type fluid displacement pumps are generally well-known in the art. Such fluid displacement pumps are advantageous in that they are capable of pumping fluids while isolating the fluids from the external environment in that during pumping, the fluids pass through one or more sealed passages and are not subject to contamination or fluid loss. These pumps have been adapted for use in many applications including those requiring extremely accurate delivery of a liquid to a point of use. Such applications include, for example, the delivery of liquids in medical instrumentation, the precision fueling of engines and the delivery of liquid ink to continuous ink-jet printer heads.

Gerotor and trochoidal gear fluid displacement pumps can handle an extremely wide range of fluids from gasoline to high viscosity chemicals, and can be optimized to meet a diverse array of operational and performance requirements. Such pumps are found in virtually every major equipment market including commercial aircraft engines, power generation equipment, chemical transfer and metering equipment, hydraulic power equipment, passenger vehicles, and heavy duty mobile equipment.

Gerotor and trochoidal gear fluid displacement pumps are a study in basic kinematics: the rotation of two conjugately formed profiles, whose centerlines are positioned at a fixed eccentricity. The expansion pockets create a vacuum causing fluid to be drawn into the pump as the gears unmesh. As rotation continues, these pockets expand and eventually reach their maximum volume, at which point fluid becomes sealed-off from the inlet side of the pump. Further rotation causes the pocket volume to decrease forcing the fluid out through a discharge port of the pump. While fluid is carried from inlet to outlet, a positive seal is maintained as the inner gear teeth follow the contour of crests and valleys of the outer gear.

In conventional configurations, gerotor and trochoidal gear fluid displacement pumps often include a gear-assembly section and a drive-assembly section. The fluid flowing through the pump passes through the gear-assembly section. Often, there is also a need to provide fluid in the drive-assembly section. For example, the drive assembly may include moving parts that are in frictional contact, thereby generating heat and wear. Passing fluid between these moving parts can act as a lubricant, reducing heat and wear. Magnetically coupled drive mechanisms have been known to serve to eliminate leak-prone hydraulic seals around drive shafts.

Despite generally eliminating the need for a conventional shaft seal, prior art magnetically coupled gear pumps require a sealing partition between the gear-assembly section and the magnet-coupling section of the pump. These seals are critical components subject to wear, binding, abrasion, and various other problems.

Magnetically coupled gear pumps typically include an outer annular magnet turned or rotated by a motor (i.e., the “driving” magnet). An annular inner magnet is carried on a drive shaft (i.e., the “driven” magnet). The inner magnet is typically isolated from the outer magnet by a thin metallic or plastic cup.

Other designs have also been proposed. U.S. Patents proposing gear pumps include U.S. Pat. No. 1,648,730 issued to Hill, U.S. Pat. No. 4,013,388 issued to Stratman, U.S. Pat. No. 4,629,399 issued to Friebe, U.S. Pat. No. 4,747,744 issued to Dominique, et al., U.S. Pat. No. 4,820,138 issued to Bollinger, U.S. Pat. No. 4,869,654 issued to Klaus, U.S. Pat. No. 4,998,863 issued to Klaus, U.S. Pat. No. 5,090,883 issued to Krauter, et al., U.S. Pat. No. 5,139,395 issued to Kemmer, U.S. Pat. No. 5,708,313 issued to Bowes et al., U.S. Pat. No. 6,174,151 issued to Yarr, U.S. Pat. No. 6,544,019 issued to Martin, et al. and U.S. Pat. No. 6,551,070 issued to Burns, et al.

Despite these advances in the art, current internal gear pumps are rather expensive to produce, in large part, due to the fact that extensive machining is required during fabrication, while effective dynamic sealing has proved challenging. Therefore, what is needed is an internal gear fluid displacement pump having enhanced sealing properties that is capable of handling both volatile and corrosive fluids, while possessing superior reliability.

### SUMMARY

In one aspect, the present invention is directed to an internal gear fluid displacement pump. The fluid displacement pump includes an outer gear having internal teeth disposed about an inner surface thereof, an annular element constituting the rotor of an electric motor, this element having an internal diameter substantially equivalent to an external diameter of the outer gear, the annular motor rotor affixed to the outer gear, an inner gear having external teeth disposed about an outer surface thereof for meshing with the internal teeth of the outer gear, the inner gear having fewer teeth than the outer gear, the internal teeth of the outer gear and the external teeth of the inner gear defining a plurality of expansion and pumping chambers when the outer gear is rotatably driven by the electric motor rotor, a manifold plate for axially defining a first end of the pumping chambers and having a suction opening in a region of the expanding pumping chambers and a discharge opening in a region of the contracting pumping chambers, an internal plate for axially defining a second end of the pumping chambers and having a bearing surface thereon, the bearing surface operable to support the outer gear during rotation thereof, a motor stator element electromagnetically engaging the annular motor rotor element for rotationally driving the outer gear, the motor stator having a plurality of coil windings disposed about a magnetically soft ferromagnetic core and a non-magnetic housing disposed between the motor stator coil windings and the annular magnet, the outer diameter of the annular motor rotor element and the inner diameter of the non-magnetic housing constituting a journal and bearing system which is lubricated by the pumped fluid and is effective to maintain a fixed electromagnetic circuit gap between the inner diameter of the motor stator and the outer diameter of the annular motor rotor element during the operation of the pump.

In another aspect, a fuel system for use with an engine is provided. The fuel system includes an internal gear fluid displacement pump, said internal gear fluid displacement pump having an outer gear having internal teeth disposed about an inner surface thereof, an annular magnet having an internal diameter substantially equivalent to an external diameter of said outer gear, said annular magnet affixed to said outer gear, an inner gear having external teeth disposed about an outer surface thereof for meshing with said internal teeth of said outer gear, said inner gear having fewer teeth than said outer gear, said internal teeth of said outer gear and said external teeth of said inner gear defining a plurality of expansion and pumping chambers when said gear pump is rotatably driven, a manifold plate for axially defining a first end of said pumping chambers and having a suction opening in a region of said expansion pumping chambers and a discharge opening in a region of said pumping chambers, an internal plate for axially defining a second end of said pumping chambers and having a bearing surface thereon, said bearing surface operable to support said outer gear during rotation thereof, a motor for radially driving said outer gear, said motor having a plurality of coil windings, and a non-magnetic housing disposed between said motor coil windings and said annular magnet, the outer diameter of the annular motor rotor element and the inner diameter of the non-magnetic housing constituting a journal and bearing system which is lubricated by the pumped fuel and is effective to maintain a fixed electromagnetic circuit gap between the inner diameter of the motor stator and the outer diameter of the annular motor rotor element during the operation of the pump, at least one means for metering fuel having an inlet and a discharge, said inlet in fluid communication with said internal gear fluid displacement pump, and a controller to control the supply of fuel from said discharge of said at least one means for metering fuel to the engine.

In a still other aspect of the present invention, various embodiments for minimizing contact and resulting rubbing between the magnetic material and the inner surface of the pump housing are provided. In a preferred embodiment, a sleeve is provided around the magnet with such sleeve acting as a bearing surface. Alternatively, an intermediate sleeve may be fixed around the outer gear of the pump such that the sleeve protrudes into a circular slot on the face plate thus allowing the sleeve to act as a bearing surface.

In yet another aspect, a method of delivering fuel to an engine is provided. The method includes the steps of drawing fuel into at least one expansion chamber of a fluid displacement pump, the at least one expansion chamber formed by a set of gears rotatably driven, the set of gears having an outer gear having internal teeth disposed about an inner surface thereof and a circumferential surface having an annular magnet disposed about the circumferential surface, the annular magnet having a circumferential surface and an inner gear having external teeth disposed about an outer surface thereof for meshing with said internal teeth of said outer gear, rotatably driving the outer gear of the set of gears by driving currents through a set of electrical motor stator coil windings circumferentially disposed about the annular magnet, transferring the fuel from the at least one expansion chamber to at least one pumping chamber formed by the set of gears to elevate the pressure of the fuel, and delivering the fuel at the elevated pressure to an engine, wherein the inner gear has fewer teeth than the outer gear and the internal teeth of the outer gear and the external teeth of the inner gear define the expansion and pumping chambers.

### BRIEF DESCRIPTION OF THE DRAWINGS

The invention will now be described in more detail with reference to preferred forms of the invention, given only by way of example, and with reference to the accompanying drawings, in which:

FIG. 1 presents an exploded view of an internal gear fluid displacement pump, in accordance with a preferred form;

FIG. 2 is top plan view of an internal gear fluid displacement pump, in accordance with a preferred form;

FIG. 3 is a cross-sectional view of the internal gear fluid displacement pump of FIG. 2, taken along line A—A;

FIG. 4 is a cross-sectional schematic illustration of an internal gear fluid displacement pump.

FIG. 5 (a-i) is a schematic illustration of the operation of an internal gear fluid displacement pump in various steps during the pumping operation;

FIG. 6 is a schematic of a fuel supply system for an internal combustion engine, in accordance with another preferred form;

FIG. 7 is a schematic of a fuel supply system for an external combustion engine, in accordance with yet another preferred form;

### DETAILED DESCRIPTION

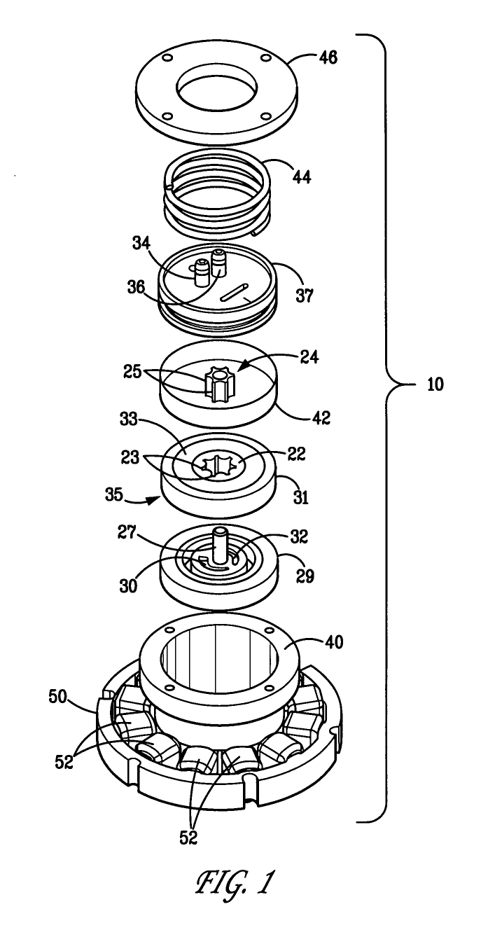

Reference is now made to the embodiments illustrated in FIGS. 1-7 wherein like numerals are used to designate like parts throughout.

Referring now to FIGS. 1 through 4, an internal gear fluid displacement pump 10 is shown. The internal gear fluid displacement pump 10 includes an outer gear 22 with inner teeth 23 and an inner gear 24 with outer teeth 25. The inner gear 24 has fewer teeth 25 than the outer gear 22 and is arranged eccentrically with respect to the outer gear 22 so that the teeth 25 of the inner gear 24 engage inner teeth 23 of the outer gear 22. Inner teeth 23 of outer gear 22 and outer teeth 25 of inner gear 24, during operation of the internal gear fluid displacement pump 10, define expansion and pumping chambers that provide for pumping of the supply fluid, which may be a fuel, such as gasoline, diesel fuel, kerosene, oxygenates oxygenated blends or the like. Outer gear 22 and inner gear 24 may be formed from various materials as is known in the art including, for example, various plastics or sintered metals.

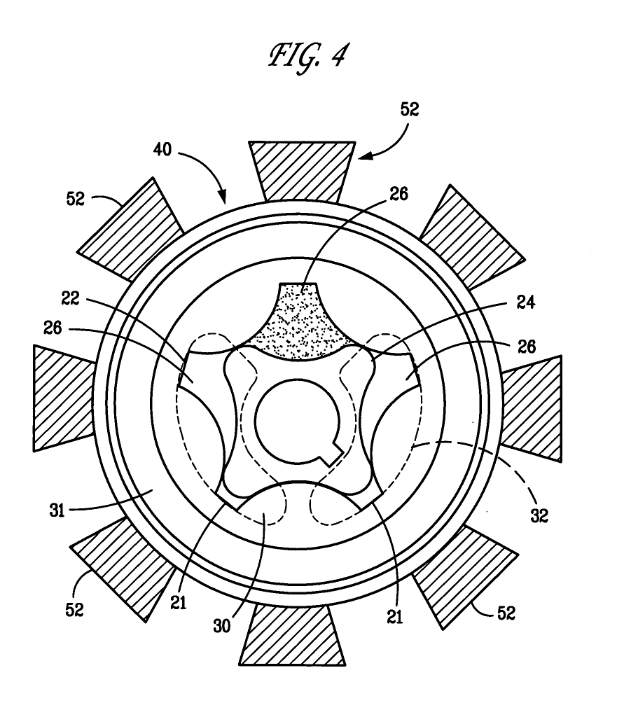

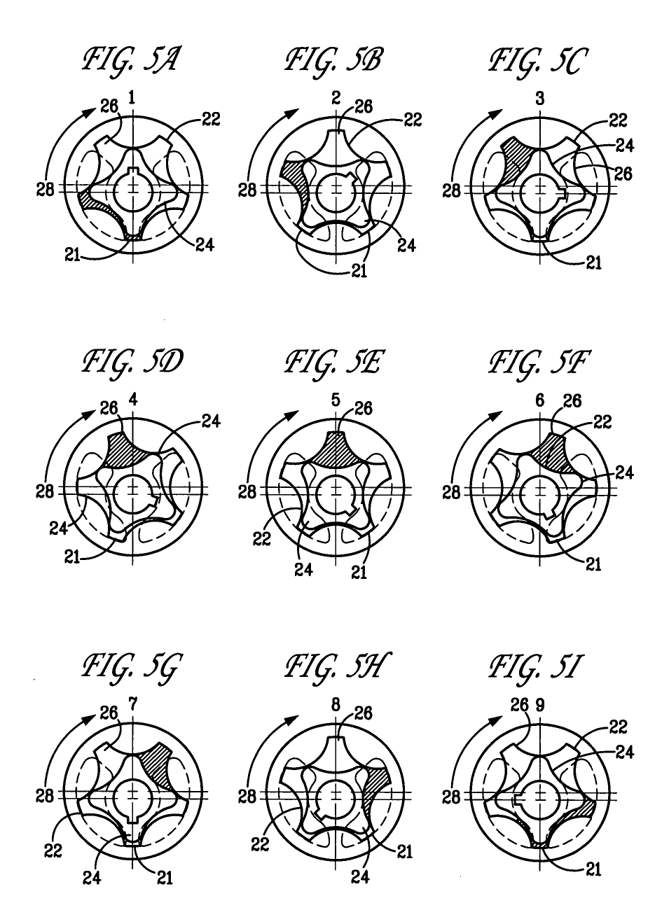

Referring now to FIG. 4 and FIG. 5 (a-i), internal gear fluid displacement pump 10 operates by having both inner gear 24 and outer gear 22 free to rotate, while their respective centerlines are at a fixed eccentricity. The direction of rotation of the outer gear 22 is shown with arrow 28. As indicated, inner gear 24 is rotatable, with a single alignment pin holding inner gear 24 eccentric. It is possible to reverse the direction of pump rotation from that shown in the Figures (i.e. outer gear 22 and inner gear 24 both rotate counterclockwise). In such event, the corresponding flow direction will be reversed.

Fluid is continuously drawn into the expansion chambers 26 (see FIG. 5 (a-d)) and then the volume of that chamber decreases (see FIG. 5 (e-i)) forcing the liquid out of the port, shown by dotted lines. In the regions of the chambers acting as expansion chamber 26, there is provided a crescent-shaped inlet opening 30, shown in dotted lines, through which the fluid is admitted in the expansion chamber 26. In the region of the chambers acting as pumping (compression) chambers 21, there is provided a likewise crescent-shaped outlet opening 32, also shown in dashed lines. The openings are provided in plates 29 and 37 which limit the expansion chambers 26 and pumping chambers 21 in an axial direction. The inner gear 24 requires a stationary guide so that its position with respect to the outer gear 22 does not change during operation of the internal gear fluid displacement pump 10. This feature will be discussed in more detail below.

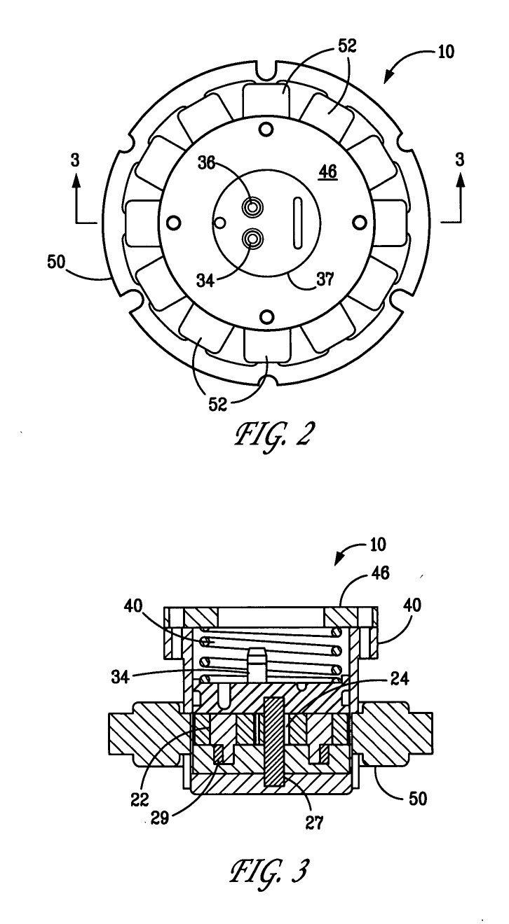

FIG. 3 shows a longitudinal cross-sectional view of internal gear fluid displacement pump 10 taken along line A-A of FIG. 2. The inner gear 24 is rotatably supported on a guide pin 27. Guide pin 27 is fixed in plate 29. As shown in FIG. 3, the outer circumferential surface of outer gear 22 is surrounded by a ring 33, the inner wall of which is in interfering engagement with the outer circumferential surface of the outer gear 22. Ring 33 protrudes into a circular slot in plate 29 to act as a bearing surface which prevents magnet 31 from rubbing against housing 40. The protrusion may alternatively be included in outer gear 22 to avoid the need for a separate sleeve. Alternatively, a sleeve (not shown) may be provided around magnet 31 to accomplish the same effect.

A magnet 31, which may be an eight-pole magnet (or a magnet with a few more or a few less poles) as is particularly preferred, is positioned in interfering engagement with the outer circumferential surface of ring 33 to form an outer gear assembly 35. Alternatively, although not shown, magnet 31 may, instead, comprise a series of small, individual magnets which may be attached to outer gear 22 via, for example, hollowed out sections of outer gear 22.

A second plate 37 is provided on a side of outer gear assembly 35, opposite from the plate 29. The plates 29 and 37, as indicated, axially limit chambers 26 and 21 formed by teeth 23 of the outer gear 22 and teeth 25 of the inner gear 24. The inlet or suction opening 30 and the outlet or discharge opening 32 are formed in plate 29, with manifold connectors 34 and 36 formed in plate 37.

Referring still to FIGS. 1-4, to drive the outer gear assembly 35, a motor stator core and coil winding assembly (stator) 50 having a plurality of motor coils 52 is employed. A non-magnetic housing 40 is positioned between the motor coils 52 and the magnet 31. The effective gap between the motor stator core and coil winding assembly 50 and magnet 31 is not be affected by housing 40, as those skilled in the art will plainly recognize.

Various motor embodiments may be employed with particular examples now described. The motor illustrated herein may, in one embodiment, comprise either a brushless permanent magnet motor (BPMM) or a synchronous permanent magnet motor (SPMM) with an array of permanent magnets fixed to a so-called backiron sleeve which in turn mates with the outer diameter of the internal gear. The backiron sleeve may be omitted if the internal gear of the pump is comprised of a magnetically soft material such that the internal gear in that case provides the function that would otherwise be provided by the backiron sleeve. The magnet elements may be discrete but if designed on a small scale (e.g., up to 3 inch diameter array), the elements are preferably formed as separately magnetized regions of a continuous ring of magnetizable material. The field of the permanent magnet elements electromagnetically engage with the effective rotating field produced by sequential excitation of the stator element windings and thereby develop driving torque.

In an alternative embodiment of the present invention, the motor comprises a so-called “switched reluctance motor” (SRM). In this case, the rotor element is a magnetically “soft” ferromagnetic ring with a number of protrusions formed about the outside diameter. The stator is characterized by a soft ferromagnetic annular core provided with a number of protrusions about its inside diameter and coils wound about each of these. The number of rotor protrusions is typically less than those provided for the stator. With the appropriate sequential excitation of the stator windings, a rotor torque will be developed which attempts to bring the rotor protrusions into alignment with those of the stator so as to minimize the reluctance of the electromagnetic circuit formed by the rotor and stator ferromagnetic cores. Through sequential energization of appropriate stator windings, an average outer gear driving torque may be developed.

Both motor architectures offer advantages and disadvantages and the appropriate choice of motor technology is application-specific and would be determined by performance requirements and associated cost constraints.

To keep plates 29 and 37 in sealing engagement with chambers 26 and 21 of inner gear 24 and outer gear 22, a spring 44 is employed to provide the necessary tension. Cap 46 is mounted to non-magnetic housing 40 by suitable means, including screws, bolts, fasteners, epoxy, welding or the like.

As may be appreciated, during pump operation, several different external forces act on the outer gear 22. These forces include a driving force, a pressure force, a bearing force, and a frictional force. These forces are adequately balanced during operation, yielding a smooth and efficient operating fluid displacement pump. The design disclosed herein is unique because the pump rotor is attached directly to the rotor of the driving motor and the pump is effectively enclosed in a pressure vessel which is surrounded by the coil windings. Advantageously, by driving outer gear 22 in the manner described herein, rather than by driving the inner gear by an axially aligned external motor, the need for a dynamic shaft seal is eliminated, with only a single static o-ring seal or welding, gluing or crimping to create a seal being normally required. These features enhance the ability to pump corrosive liquids. Moreover, the present invention typically requires fewer parts and less machining, yielding an easy to assemble unit having superior reliability.

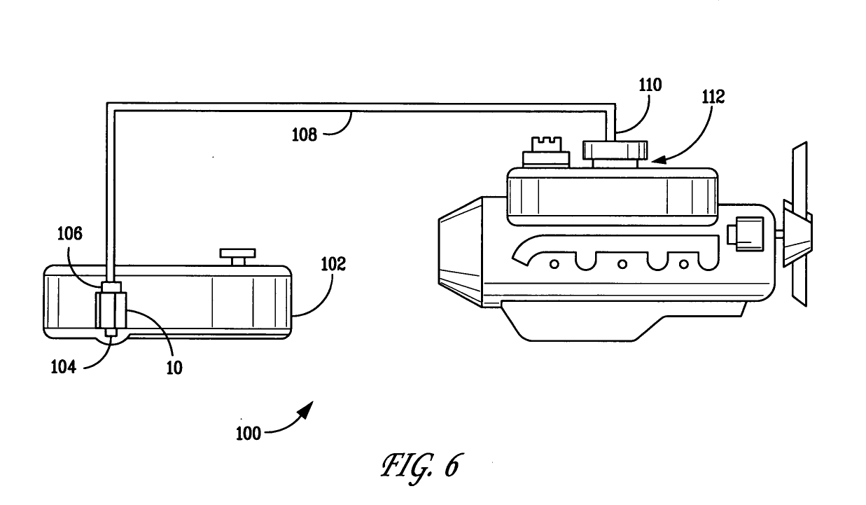

Referring now to FIG. 6, an automotive fuel system is shown. The fuel system includes a fuel storage tank 102, wherein an internal gear fluid displacement pump 10 of the type described herein is positioned. A fuel line 108 extends from an outlet fitting 106 of internal gear fluid displacement pump 10 and runs to an internal combustion engine 112 having a fuel metering system 110, which may advantageously include at least one fuel injector or, alternatively an orifice with selectively controlled fuel pressure. The internal gear fluid displacement pump 10 delivers fuel from the fuel storage tank 102 to the internal combustion engine 112 during operation thereof. Although the internal gear fluid displacement pump 10 is shown located within fuel storage tank 102, other arrangements are contemplated, such as located internal gear fluid displacement pump 10 external to fuel storage tank 102.

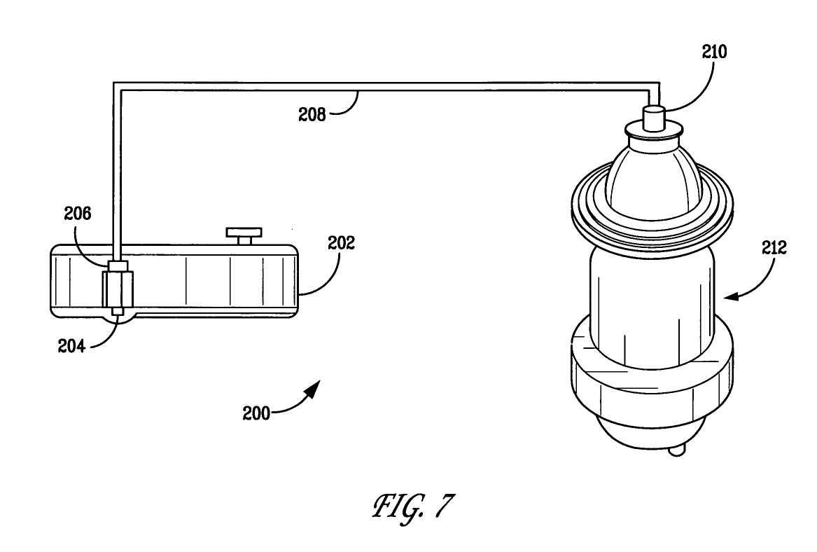

Referring now to FIG. 7, a fuel system for a small Stirling engine 212 is shown. The fuel system includes a fuel storage tank 202, wherein an internal gear fluid displacement pump 10 of the type described herein is positioned. A fuel line 208 extends from an outlet fitting 206 of internal gear fluid displacement pump 10 and runs to Stirling engine 212 having at least one fuel injector 210. The internal gear fluid displacement pump 10 delivers fuel from the fuel storage tank 202 to the Stirling engine 212 during its operation. As with the fuel system of FIG. 6, although the internal gear fluid displacement pump 10 is shown located within fuel storage tank 202, other arrangements are contemplated, such as located internal gear fluid displacement pump 10 external to fuel storage tank 202.

While the internal gear fluid displacement pump shown in FIGS. 1-5 (a-i) may be seen to employ a gerotor gear set, other well known mechanisms are suitable for this application. For example, trochoidal gear sets are particularly suitable, as they possess good pressure angles and may be easily constructed. As is known by those skilled in the art, a trochoidal gear set skips two teeth for every orbit of the inner gear, since there is a difference of two teeth between the inner and outer gears, rather than the one tooth difference of the gerotor gear set. Thus it is possible to get the same action with the trochoidal gear set as with the gerotor gear set. Advantageously, additional gear ratios are obtainable with a trochoidal gear set which would be unobtainable with the gerotor gear set.

Other mechanisms which could be suitable for this application might be a bevel gear set, a planetary gear set where the outer gear, carrier and sun gear turn. Reference to a gear set as used herein is intended to include suitable alternative mechanisms.

While the subject invention has been illustrated and described in detail in the drawings and foregoing description, the disclosed embodiments are illustrative and not restrictive in character. All changes and modifications that come within the scope of the invention are desired to be protected.

1. An internal gear fluid displacement pump comprising:
(a) an outer gear having internal teeth disposed about an inner surface thereof;
(b) an annular magnet constituting the rotor element of a brushless permanent magnet motor driven by non-sinusoidal currents, said annular magnet having an internal diameter substantially equivalent to an external diameter of said outer gear, said annular magnet affixed to said outer gear;
(c) an inner gear having external teeth disposed about an outer surface thereof for meshing with said internal teeth of said outer gear, said inner gear having fewer teeth than said outer gear, said internal teeth of said outer gear and said external teeth of said inner gear defining a plurality of pumping chambers and a plurality of expansion chambers when said gear pump is rotatably driven;
(d) a manifold plate for axially defining a first end of said pumping chambers and having a suction opening in a region of said expansion chambers and a discharge opening in a region of said pumping chambers;
(e) an internal plate for axially defining a second end of said pumping chambers and having a bearing surface thereon, said bearing surface operable to support said inner and outer gear during rotation thereof;
(f) a motor stator for radially driving said outer gear, said motor stator having a soft ferromagnetic core and coil winding assembly; and
(g) a non-magnetic housing disposed between said motor stator core and coil winding assembly and said annular magnet, said non-magnetic housing effective to maintain a gap between said motor stator core and coil winding assembly and said annular magnet during the operation of the pump.

2. The pump of claim 1, wherein said inner gear has one less tooth than said outer gear, so as to form a gerotor pump.

3. The pump of claim 1, wherein said inner gear has two less teeth than said outer gear, so as to form a trochoidal pump.

4. The pump of claim 1, wherein said annular magnet has eight poles.

5. The pump of claim 4, further comprising a plate and a biasing means, said biasing means disposed between an outer surface of said manifold plate, said biasing means effective to resiliently engage said manifold plate and minimize dimensional variation of said expansion and pumping chambers when said gear pump is rotatably driven.

6. The pump of claim 1, further comprising a plate and a biasing means, said biasing means disposed between an outer surface of said manifold plate, said biasing means effective to resiliently engage said manifold plate and minimize dimensional variation of said expansion and pumping chambers when said gear pump is rotatably driven.

7. The pump of claim 6, wherein the pump is effectively sealed in the absence of a dynamic shaft seal.

8. The pump of claim 1, wherein the pump is effectively sealed in the absence of a dynamic shaft seal.

9. The pump of claim 1, wherein said inner gear and said outer gear are formed of sintered metal.

10. The pump of claim 1, wherein said inner gear and said outer gear are formed of plastic.

11. The pump of claim 1, wherein said inner gear is fixed in an eccentric position by a pin, said pin having a first end and a second end, said first end engaging said internal plate, said second end engaging said manifold plate.

12. The pump of claim 1, wherein said outer gear performs the function of a backiron sleeve.

13. The pump of claim 12 wherein said outer gear comprises a ferromagnetic material permitting said outer gear to serve as a backiron sleeve.

14. The pump of claim 1 wherein said manifold plate forms a bearing surface for the faces of said outer gear and said inner gear.

15. The pump of claim 1 wherein said internal plate comprises a second manifold plate, said second manifold plate providing a second suction opening to and a second discharge opening from said pump.

16. The pump of claim 11 wherein said pin defines the spacing between said internal plate and said manifold plate.

17. The pump of claim 11 wherein a spacer sleeve defines the spacing between said internal plate and said manifold plate.

18. The pump of claim 16 wherein said pin further defines the spacing between said inner gear and said manifold plate and the spacing between said outer gear and said internal plate.

19. The pump of claim 1 wherein said motor is operated with sinusoidal currents as a permanent magnet synchronous motor.

20. The pump of claim 1 wherein said motor comprises a switched reluctance motor.

21. The pump of claim 1 wherein said rotor element further comprises a backiron sleeve.

22. The pump of claim 1 wherein said outer gear is not comprised of a magnetically soft material.

23. The pump of claim 1 wherein the outer diameter of said annular magnet and the internal diameter of the pump housing comprises a journal and bearing system which is lubricated by the pumped fluid.

24. The pump of claim 1 further comprising a sleeve surrounding the outer diameter of said annular magnet, said sleeve serving as a bearing surface.

25. The pump of claim 1 further comprising a sleeve surrounding said outer gear and protruding into said manifold plate or said internal plate, said sleeve serving as a bearing surface.

26. A fuel system for use with an engine, comprising:
(a) an internal gear fluid displacement pump, said internal gear fluid displacement pump including: (i) an outer gear having internal teeth disposed about an inner surface thereof; (ii) an annular magnet having an internal diameter substantially equivalent to an external diameter of said outer gear, said annular magnet affixed to said outer gear; (iii) an inner gear having external teeth disposed about an outer surface thereof for meshing with said internal teeth of said outer gear, said inner gear having fewer teeth than said outer gear, said internal teeth of said outer gear and said external teeth of said inner gear defining a plurality of expansion and pumping chambers when said gear pump is rotatably driven; (iv) a manifold plate for axially defining a first end of said pumping chambers and having a suction opening in a region of said expansion pumping chambers and a discharge opening in a region of said pumping chambers; (v) an internal plate for axially defining a second end of said pumping chambers and having a bearing surface thereon, said bearing surface operable to support said outer gear during rotation thereof; (vi) a motor for radially driving said outer gear, said motor having a soft ferromagnetic core and coil winding assembly; and (vii) a non-magnetic housing disposed between said motor stator core and coil winding assembly and said annular magnet, said non-magnetic housing effective to maintain a gap between said motor stator core and said coil winding assembly and said annular magnet during the operation of the pump;
(b) at least one means for metering fuel having an inlet end and a discharge end, said inlet end in fluid communication with said internal gear fluid displacement pump; and
(c) a controller to control the supply of fuel from said discharge end of said at least one means for metering fuel to the engine.

27. The fuel system of claim 26, wherein said inner gear has one less tooth than said outer gear, so as to form a gerotor pump.

28. The fuel system of claim 26, wherein said inner gear has two less teeth than said outer gear, so as to form a trochoidal pump.

29. The fuel system of claim 26, wherein said annular magnet has eight poles.

30. The fuel system of claim 29, further comprising a plate and a biasing means, said biasing means disposed between an outer surface of said manifold plate, said biasing means effective to resiliently engage said manifold plate and minimize dimensional variation of said expansion and chambers when said gear pump is rotatably driven.

31. The fuel system of claim 26, further comprising a plate and a biasing means, said biasing means disposed between an outer surface of said manifold plate, said biasing means effective to resiliently engage said manifold plate and minimize dimensional variation of said expansion and pumping chambers when said gear pump is rotatably driven.

32. The fuel system of claim 31, wherein the pump is effectively sealed in the absence of a dynamic shaft seal.

33. The fuel system of claim 26, wherein the pump is effectively sealed in the absence of a dynamic shaft seal.

34. The fuel system of claim 26, wherein said inner gear and outer gear are formed of sintered metal.

35. The fuel system of claim 26, wherein said inner gear is fixed in an eccentric position by a pin, said pin having a first end and a second end, said first end engaging said internal plate, said second end engaging said manifold plate.

36. The fuel system of claim 26, wherein the engine is an internal combustion engine.

37. The fuel system of claim 36, wherein the internal combustion engine is a spark-ignited gasoline-powered internal combustion engine.

38. The fuel system of claim 26, wherein the engine is an external combustion engine.

39. The fuel system of claim 38, wherein the external combustion engine is a Stirling engine.

40. The fuel system of claim 26, wherein said means for metering fuel comprises a fuel injector.

41. The fuel system of claim 26, wherein said means for metering fuel comprises an orifice and a means for selectively varying fuel pressure.

42. The fuel system of claim 26, wherein said motor is operated with sinusoidal currents as a permanent magnet synchronous motor.

43. The fuel system of claim 26 wherein said motor comprises a switched reluctance motor.

44. A method of delivering fuel to an engine, comprising the steps of:
(a) drawing fuel into at least one expansion chamber of a fuel displacement pump, said at least one expansion chamber formed by a set of gears rotatably driven, the set of gears having an outer gear having internal teeth disposed about an inner surface thereof and a circumferential surface having an annular magnet disposed about the circumferential surface, the annular magnet having a circumferential surface and an inner gear having external teeth disposed about an outer surface thereof for meshing with said internal teeth of said outer gear;
(b) rotatably driving the outer gear of the set of gears by applying a current to a set of electrical motor coils circumferentially disposed about the annular magnet;
(c) transferring the fuel from the at least one expansion chamber to at least one pumping chamber formed by the set of gears to elevate the pressure of the fuel; and
(d) delivering the fuel at the elevated pressure to an engine;
wherein the inner gear has fewer teeth than the outer gear and the internal teeth of the outer gear and the external teeth of the inner gear define the expansion and pumping chambers.

45. The method of claim 44, wherein the inner gear has one less tooth than the outer gear, so as to form a gerotor pump.

46. The method of claim 44, wherein the inner gear has two less teeth than the outer gear, so as to form a trochoidal pump.

47. The method of claim 46, wherein the pump is effectively sealed in the absence of a dynamic shaft seal.

48. The method of claim 45, wherein the pump is effectively sealed in the absence of a dynamic shaft seal.

49. The method of claim 44, wherein the annular magnet has eight poles.

50. The method of claim 44, wherein the inner gear and outer gear are formed of sintered metal.

51. The method of claim 44, wherein the inner gear is fixed in an eccentric position by a pin, the pin having a first end and a second end, said first end engaging an internal plate and the second end engaging a manifold plate.

52. The method of claim 44, wherein the engine is an internal combustion engine.

53. The method of claim 52, wherein the internal combustion engine is a spark-ignited gasoline-powered internal combustion engine.

54. The method of claim 53, wherein the engine is an external combustion engine.

55. The method of claim 54, wherein the external combustion engine is a Stirling engine.

56. A gerotor pump comprising:
(a) an outer gear having internal teeth disposed about an inner surface thereof;
(b) an annular magnet constituting the rotor element of a brushless permanent magnet motor driven by non-sinusoidal currents, said annular magnet having an internal diameter substantially equivalent to an external diameter of said outer gear, said annular magnet affixed to said outer gear;
(c) an inner gear having external teeth disposed about an outer surface thereof for meshing with said internal teeth of said outer gear, said inner gear having fewer teeth than said outer gear, said internal teeth of said outer gear and said external teeth of said inner gear defining a plurality of pumping chambers and a plurality of expansion chambers when said gear pump is rotatably driven;
(d) a motor stator for radially driving said outer gear, said motor stator having a soft ferromagnetic core and coil winding assembly; and
(e) a non-magnetic housing disposed between said motor stator core and coil winding assembly and said annular magnet, said non-magnetic housing effective to maintain a gap between said motor stator core and coil winding assembly and said annular magnet during the operation of the pump.

57. The pump of claim 56, wherein said annular magnet has eight poles.

58. The pump of claim 56, further comprising:
(f) a manifold plate for axially defining a first end of said pumping chambers and having a suction opening in a region of said expansion chambers and a discharge opening in a region of said pumping chambers; and
(g) an internal plate for axially defining a second end of said pumping chambers and having a bearing surface thereon, said bearing surface operable to support said inner and outer gear during rotation thereof.

59. The pump of claim 58, further comprising a plate and a biasing means, said biasing means disposed between an outer surface of said manifold plate, said biasing means effective to resiliently engage said manifold plate and minimize dimensional variation of said expansion and pumping chambers when said gear pump is rotatably driven.

60. The pump of claim 59, wherein said inner gear is fixed in an eccentric position by a pin, said pin having a first end and a second end, said first end engaging said internal plate, said second end engaging said manifold plate.
